(19) United States
(12) Patent Application Publication
(10) Pub. No.: US 2017/0026481 A1
(43) Pub. Date: Jan. 26, 2017

(54) TECHNIQUE FOR CONTROLLING THE SERVICE REQUEST ROUTING

(71) Applicant: ORANGE, Chatilllon Cedex (FR)

(72) Inventor: Emile Stephan, Pleumeur Bodou (FR)

(73) Assignee: ORANGE, Paris (FR)

(21) Appl. No.: 15/106,758

(22) PCT Filed: Dec. 18, 2014
(86) PCT No.: PCT/FR2014/053409

§ 371 Date: Jun. 20, 2016

(30) Foreign Application Priority Data
Dec. 23, 2013 (FR) 1363473

(51) Int. Cl. H04L 29/08

(52) U.S. Cl. CPC H04L 67/2814; H04L 67/327

(57) ABSTRACT

The invention relates to a method for controlling service request routing, said method including the following steps and being implemented by a server providing said service: receiving the service request; verifying that the request was received from a proxy server in charge of controlling requests for said service; and, when said request has not been received from a proxy server in charge of controlling requests for said service, transmitting said service request to at least one proxy server in charge of controlling requests for said service.

The invention lies in the field of packet communication networks and relates more particularly to a technique for monitoring the routing of a service request.

It is commonplace for an operator of a communication network to use, in its network, proxy servers, in order to offer its subscribers value added services provided by the operator itself or by a partner of the operator. These proxy servers make it possible to analyze and enrich a request relating to a service transmitted by a client application, called “user-agent” (e.g., a browser) installed on a user terminal, or even from an equipment item that makes it possible to connect to the Internet. The analysis of the request is for example performed using a so-called deep packet inspection (DPI) technique and it is enriched by the addition of one or more HTTP (HyperText Transfer Protocol) parameters. By virtue of this enriched request, a service provider can, for example, provide functions such as parental control, geolocated services, or even a customization of the service delivered as a function of a subscriber's subscription type. The proxy servers are also generally located at the interface of a number of communication networks. They make it possible in particular to differentiate the traffic intended for the operator, for a partner of the operator, or even for a third-party network.

The next version of the HTTP protocol, “HTTP 2.0”, currently under discussion within the “Hypertext Transfer Protocol Bis (httpbis) working group of the IETF (Internet Engineering Task Force), implements functions which increase the complexity of the analysis and the enrichment of the requests relating to a service transmitted from, for example, a browser. The HTTP 2.0 protocol in particular allows for a multiplexing of the exchanges, an interleaving of these exchanges, a compression of the headers which relate thereto, and also for them to be secured using the TLS (Transport Layer Security) protocol. These new functions require appropriate processing by the network operator in order to ensure continuity of the value added services offered to its subscribers. For that, the network operator associates a proxy server with one or more services offered by the operator or a service provider to which to route the requests relating to one of these services. This association is not however always observed. The routing of these requests to the proxy server associated with a service may in fact not be taken into account, or the requests for this service may be redirected by a browser, or even rerouted by a network equipment item. That may in particular result in a routing to a proxy server unsuited to the processing of the requested service. The absence of analysis and/or of enrichment of the request relating to the requested service by a proxy server responsible for monitoring requests for the service can notably be reflected in billing problems linked to the service (e.g. billing for a free service), a degradation of the service requested or subscribed to by a subscriber, or even an inability of the operator or the service provider to deliver it.

One of the aims of the invention is to remedy the inadequacies/drawbacks of the prior art and/or to provide improvements thereto.

According to a first aspect, the invention relates to a method for monitoring the routing of a request relating to a service, the method comprising the following steps implemented by a server providing the service:
reception of the request relating to a service;
checking that the request has been received from a proxy server responsible for monitoring requests for the service;

and when the request has not been received from a proxy server responsible for monitoring requests for the service:
transmission of the request relating to a service to at least one proxy server responsible for monitoring requests for the service.

The method makes it possible to guarantee, to a service provider in a relationship of trust with a third party, a supervision and/or a processing of requests which are intended for it. The supervision and/or the processing of the requests are for example defined contractually between the service provider and this third party to which these operations are delegated. This relationship of trust is embodied notably in the use of a proxy server responsible for monitoring requests for the requested service during their routing. It is stressed that this proxy server responsible for monitoring requests for the service is for example monitored by the third party, which notably means that the proxy server is managed by the third party or even that it has been approved by this third party. This trusted third party can in particular be a communication network operator.

The method more particularly makes it possible to reorient a request to a network equipment item approved by a trusted third party, when the request has not been received from such an equipment item by the service provider. Measures can be taken that make it possible to ensure the continuity of the services delegated by the service provider to the proxy server monitored by the third party. The method thus makes it possible for the third party to enrich the requests sent to the service provider (e.g., enrichment with information relating to a location of the user terminal, with information relating to a subscription type), to filter them (e.g. parental control, restriction of access for a subscription type), to analyze them (e.g. production of statistics relating to observed traffic), or even to convert them into a format that is appropriate for the service provider (e.g. conversion of a request transmitted in accordance with the HTTP 2.0 protocol into a request conforming to the HTTP 1 protocol, encryption of the request). It also makes it possible for the operator of the communication network to perform billing calculations relating to the traffic to the service provider. The method also makes it possible to avoid a degraded user experience on the part of a subscriber of the communication network operator due to a partial provision of a service or the inability of the service provider to deliver a service.

Furthermore, the method makes it possible to protect the service provider from a problem of security linked to a routing of the request to an equipment item of the network susceptible to abuse concerning the content of the request or to the service provider. In particular, it makes it possible to assure the service provider that the request has reached the service provider via a trusted third party, and therefore to guarantee a secured route for the latter.

The method also makes it possible to correct an error of routing of the request transmitted by a browser. It notably makes it possible to inform the third party of an absence of inclusion by a browser, in the routing of the request, of a proxy server recommended by the third party.

According to a particular feature, the request is received from a proxy server, the check comprising the search for the proxy server in a list of at least one proxy server responsible for monitoring requests for the service.

The check that the proxy server from which the request is received is indeed a proxy server responsible for monitoring requests for the service enables the service provider to ensure that this request has not been intercepted by a proxy server not approved by a trusted third party. Problems of security and of confidentiality of the user information are thus avoided.

According to a particular feature, the method comprises the obtaining of the list from a resolution server, in particular a domain name resolution server, an application traffic optimization server or a conversational call setup server.

The interrogation of a resolution server, in particular of a domain name resolution server enables the service provider to obtain a list of proxy servers responsible for monitoring requests for the service associated with a domain name of this provider. In particular, it makes it possible not to invoke a third party responsible for the management of these proxy servers on each request received in the checking step, which also simplifies the deployment of the method in a network infrastructure of the service provider.

According to a particular feature, the method comprises the search, in the list, for information identifying a proxy server connected with the equipment item having transmitted the request, the transmission step consisting in sending the request to the identified proxy server.

The server list obtained from the resolution server can contain information identifying a proxy server connected with the equipment item having transmitted the request. When such a server is identified, the request can advantageously be sent to this server. In the case for example of a connection already set up according to the HTTP2/TLS protocol, the processing of the request can be directly taken over by the identified proxy server. Since the negotiation of a new TLS session is avoided, the processing of the request is also accelerated. Furthermore, unlike a redirection of the request to the identified proxy server, the request does not pass once again through the proxy server via which it was initially received. A potential interception of the request thereby is thus avoided.

According to a particular feature, the list is supplied to the server providing the service prior to the reception of the request relating to the service.

The provision to the server providing the service of a list of proxy servers responsible for the monitoring of requests for this service, prior to the reception of the request, makes it possible for the service provider to have an up-to-date list of proxy servers. It also makes it possible, when this list is, for example, defined in a parameterizing of the service provider, to offer a greater seal-tightness of the network and therefore a better protection against attacks targeting the service provider.

According to a particular feature, the monitoring method further comprises the following steps implemented by a proxy server responsible for monitoring requests for the service on reception of the transmitted request:
determination that the request has passed through a proxy server not responsible for monitoring requests for the service;
application of a corrective action relating to the request.

The method makes it possible for a proxy server to determine whether a request has been received directly from a browser or from another application allowing access to the Internet according to a normal mode of operation, or even to determine whether the latter has passed through a proxy server not monitored by a trusted third party before being received. In the latter case, the method makes it possible to execute a corrective action applied to the request in order, for example, to deliver the requested service, or else to execute a preventive action in order, for example to warn a user of a potential security fault relating to his or her browser or to the application that he or she has used to transmit the request.

According to a particular feature, the corrective action belongs to a group comprising the sending of a notification to an equipment item transmitting the request, the sending of a notification to the proxy server not responsible for monitoring requests for the service through which the request has passed, a processing of the request in order to make the service requested, a recording of the request, a limitation of the resources of the network assigned for the processing of the request.

The sending of a notification to the equipment item transmitting the request offers the advantage already mentioned previously of informing a user of a potential security fault relating for example to his or her browser. The sending of a notification to the proxy server through which the request has passed makes it possible to transmit a warning in respect thereof when the latter has not observed the routing recommended for the requested service. The recording of the request makes it possible to produce statistics relating to a nonconforming routing of requests received by the proxy server responsible for monitoring requests for the service. These statistics also provide information on the frequency of occurrence of a nonconforming routing for a given application, making it possible to determine whether the routing error is of a trivial nature or not. A limitation of the resources of the network assigned for the processing of the request is also made possible by the method.

According to a particular feature, the transmission step of the method consists in redirecting the request to at least one proxy server via the equipment item transmitting the request.

The redirection of the request via the equipment item transmitting the request enables the server to reuse an existing mechanism, and therefore simplifies the implementation of the method in existing infrastructure equipment items. Furthermore, since the request passes once again, upon a redirection, through the proxy server not responsible for the monitoring of requests for the service, an incorrect routing of the request can easily be detected by the proxy server to which it is redirected.

According to a second aspect, the subject of the invention is a server arranged to monitor a routing of a request relating to a service, comprising:
a reception module arranged to receive the request;
a sending module arranged to transmit the request to at least one proxy server responsible for monitoring requests for the service;
a monitoring module arranged to check that the request has been received from a proxy server responsible for monitoring requests for the service;
a control module arranged to, when the request has not been received from a proxy server responsible for monitoring requests for the service, control a transmission of the request relating to a service to at least one proxy server responsible for monitoring requests for the service.

The advantages expressed for any one of the features of the monitoring method implemented by the server providing the service according to the first aspect can be directly transposed to the server according to the second aspect.

According to a particular feature, the server comprises an interrogation module arranged to interrogate a resolution server to obtain a list of at least one proxy server responsible for monitoring requests for the service.

According to a third aspect, the invention relates to a proxy server arranged to detect, upon the reception of a request relating to a service, a routing of the request to a proxy server not responsible for monitoring requests, comprising:
a reception module arranged to receive the request;
a monitoring module arranged to determine that the request has passed through a proxy server not responsible for monitoring requests;
a control module arranged to control the application of a corrective action relating to the request;
a sending module arranged to send a request following a command for an application of a corrective action relating to the request.

The advantages expressed for any one of the features of the monitoring method implemented by the proxy server according to the first aspect can be directly transposed to the proxy server according to the third aspect.

According to a fourth aspect, the subject of the invention is a monitoring system, arranged to monitor the routing of a request relating to a service, comprising:
a server according to the second aspect;
a proxy server according to the third aspect.

The advantages expressed for any one of the features of the monitoring method according to the first aspect can be directly transposed to the system according to the fourth aspect.

According to a fifth aspect, the invention relates also to a program for a server arranged to monitor the routing of a request relating to a service and for a proxy server, comprising program code instructions intended to control the execution of the steps of the method described previously, when said program is run by said servers and a storage medium that can be read by a server on which a program for a server is stored.

The invention will be better understood using the following description of particular embodiments, referring to the attached drawings in which:

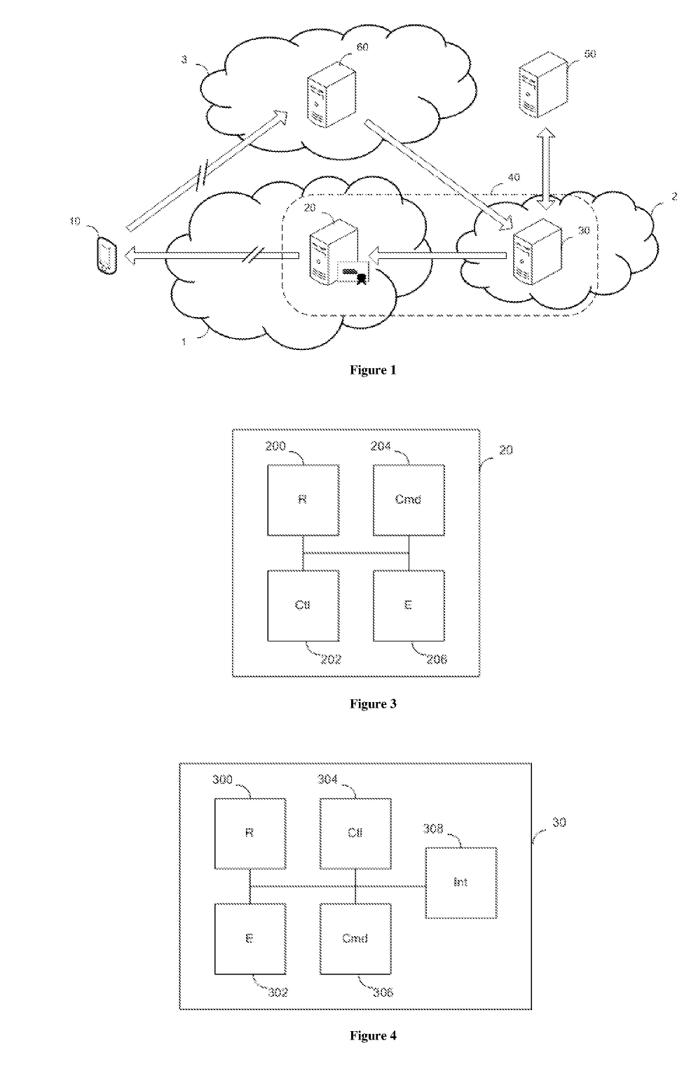

FIG. 1 represents a system for monitoring the routing of a request relating to a service according to a particular embodiment;

FIG. 2a represents a schematic diagram of the steps of the method for monitoring the routing of a request relating to a service and of the exchanges between equipment items implementing the method according to a first particular embodiment;

FIG. 2b represents a schematic diagram of the steps of the method for monitoring the routing of a request relating to a service and of the exchanges between equipment items implementing the method according to a second particular embodiment;

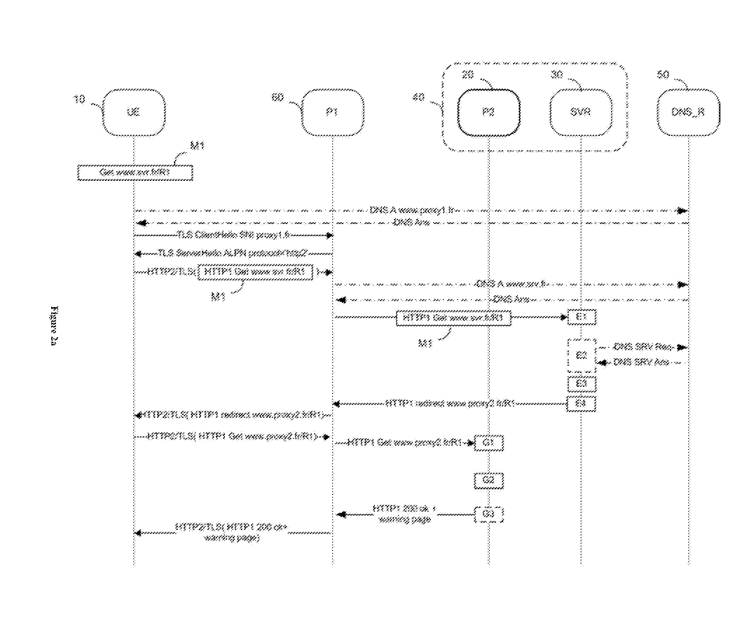

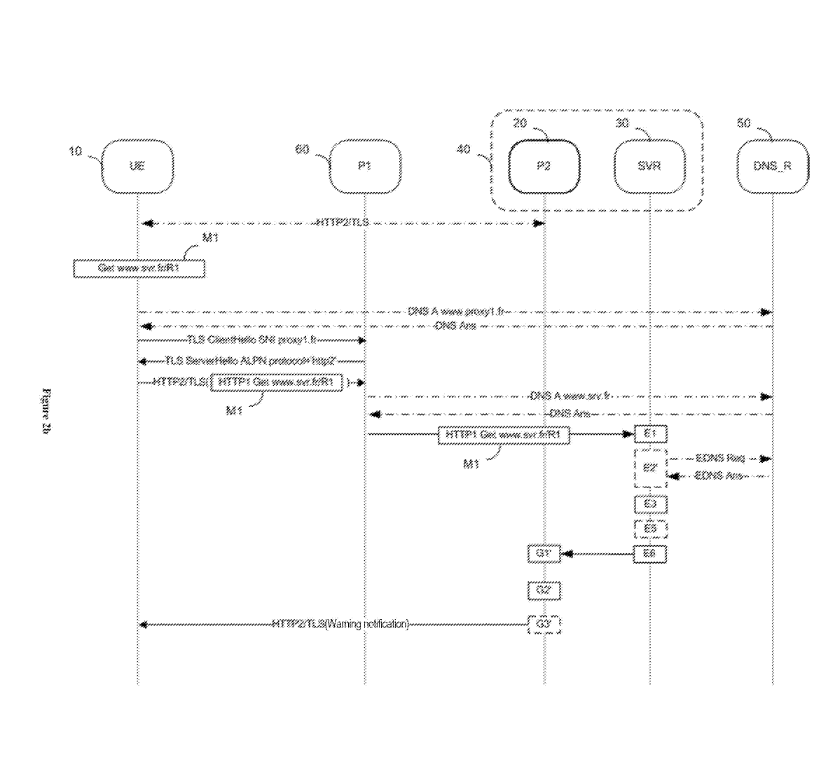

FIG. 3 represents a proxy server according to a particular embodiment;

FIG. 4 represents a server arranged to monitor a routing in a communication network of a request relating to a service transmitted by a user terminal according to a particular embodiment.

FIG. 1 represents a system 40 for monitoring the routing of a request relating to a service according to a particular embodiment. The system 40 comprises a proxy server 20 and a server 30 arranged to provide a requested service and monitor the routing of a request relating to that service. The request is transmitted by a user terminal 10 (e.g. computer, cell phone, tablet). The proxy server 20 is, for example, a dedicated physical equipment item located in a network 1 of a network operator. In another embodiment, the proxy server is a module incorporated in an equipment item of the network 1 (e.g. router, access gateway). The proxy server 20 is, in particular, monitored by the operator of the network 1. The server 30 is located in a network and communicates with a resolution server 50, for example a domain name resolution server. A proxy server 60 not monitored by the operator of the network 1 is also represented. The latter proxy server 60, by way of illustrative example, belongs to a third-party network 3.

In this embodiment, a request relating to a service provided by the server 30 is transmitted from a browser installed on the user terminal 10. This request is for example a request conforming to the HTTP 2.0 protocol and relating to an audio resource provided by the server 30. The request is transmitted to the server 30 and also requires enrichment by the proxy server 20 monitored by the operator of the network 1 in order to deliver the service requested by the user terminal 10. The request is first of all routed by the browser to the proxy server 60, before being sent to the server 30. The server 30 checks that it has received the request from a proxy server monitored by the operator of the network 1. It interrogates the domain name resolution server 50 in order to obtain a list of proxy servers monitored by the operator of the network 1 associated with its domain name. If the proxy server 60 is not in this list, the server 30 redirects the service request to a proxy server 20 belonging to this list and monitored by the operator of the network 1. The proxy server 20 monitored by the network operator receives the redirected request and detects that it has not been correctly routed. It then informs the user terminal originating the request thereof.

Three networks are represented in FIG. 1, but there is no limitation as to the location of the proxy servers 20 and 60, and of the server 30 providing the service. In particular, the servers 20, 30 and 60 can be located in one and the same network. This is generally the case for the servers 20 and 30 when the operator of the network is also the provider of the requested service.

FIG. 2a represents a schematic diagram of the steps of the method for monitoring the routing of a request relating to a service and of the exchanges between the equipment items implementing the method according to a first particular embodiment.

In the embodiment described in relation to FIG. 2, a subscriber of a network operator requests a service of a server 30 via his or her user terminal UE 10. The server 30 belongs, for example, to a service provider that has delegated to the network operator an identification of a subscription type in order to be able to deliver a customized service to the subscriber. The identification of the subscription type is performed by a proxy server P2 20 monitored by the network operator and associated with a domain name of the server SVR 30. This association is in particular made public by the completion of the “name” field of a service DNS (Domain Name System) record or “SVR record” associated with the domain name of the service provider, with the domain name of the proxy server P2 20. The service record is more particularly defined in an IETF document, RFC 2782. In the embodiment described, another function of the proxy server P2 20 is to translate requests transmitted in accordance with the HTTP version 1.x protocol into HTTP 2.0 requests and vice versa. The expression HTTP version 1.x equally designates the HTTP protocols in versions 1.0 and 1.1 thereof. Hereinbelow, the expression “HTTP1” refers to these different versions of the HTTP protocol.

The user terminal UE 10 transmits a request M1 relating to the service provided by the server SVR 30 that has, for example, the domain name “svr.fr”. There is no limitation as to the service offered by the server SVR 30. This service consists for example in the provision of an HTML (Hypertext Markup Language) page to be displayed on the screen of the user terminal UE 10, in the provision of an audio or video stream, or of any other service that can be delivered via a client-server communication protocol such as the HTTP protocol. As an illustrative example, the request M1 transmitted is an HTTP1 “Get www.svr.fr/R1” request. This request M1 is transmitted from an application (e.g. a browser) installed on the user terminal UE 10, and indicates, more particularly, that the application is requesting a resource R1 hosted by the domain name server SVR 30 “svr.fr”.

The application installed on the user terminal UE 10 does not take account of the proxy server P2 20 associated with the domain name of the service provider offering the requested service and then interrogates a domain name resolution server DNS_R 50 in order to obtain an IP (Internet Protocol) address of a proxy server P1 60 not monitored by the network operator. This interrogation is, for example, a “DNS A www.proxy1.fr” request making it possible to obtain a type A DNS record as defined in a IETF document RFC 1035, containing an IPv4 (Internet Protocol version 4) address associated with the domain name proxy server P1 60 “proxy1.fr”.

After having received the IP address of the proxy server P1 60, the application installed on the user terminal UE 10 initiates a secured TLS exchange session with the proxy server P1 60. For that, two messages, “TLS ClientHello SNI proxy1.fr” and “TLS ServerHello ALPN protocol=‘http2’” are in particular exchanged. The protocol chosen for the rest of the exchanges between the user terminal 10 and the proxy server P1 60 is determined in this TLS negotiation. In the embodiment described, it is the HTTP 2.0 protocol.

Once the TLS session is negotiated, the requests transmitted by the application are encrypted and sent using the HTTP 2.0 protocol. The request M1 transmitted is thus routed to the proxy server P1 60, not monitored by the network operator.

The proxy server P1 60 interrogates the domain name resolution server DNS_R_50 in order to obtain an IP address corresponding to the domain name “svr.fr” of the server SVR 30 providing the service requested by the request M1. The domain name resolution server DNS_R 50 then returns to the proxy server P1 60 an IP address making it possible to transmit the request to the server SVR 30.

The method for monitoring the routing of the request M1 implemented by the monitoring system 40 begins on reception of the request M1 by the server SVR 30, in a step E1.

In a step E2, the server SVR 30 interrogates a domain name resolution server DNS_R 50 in order to obtain a list of proxy servers monitored by the network operator, associated with its domain name. More specifically, a DNS SRV request is sent by the server SVR 30 to a domain name server to obtain a list L of SRV records associated with the domain name “svr.fr”. The list L obtained by the server SVR 30 comprises in particular an SRV record with a “name” field completed with the domain name “proxy2.fr” of the proxy server P2 20.

In a step E3, the server SVR 30 checks that it has received the request M1 from a proxy server monitored by the network operator. The server SVR 30 determines the domain name of the transmitter of the request M1 that it has received in the step E1. This domain name is for example obtained by reverse DNS resolution from the source IP address extracted from the header of an IP packet in which the request M1 is encapsulated. The domain name of the transmitter of the duly extracted request M1, “proxy1.fr”, is compared to the domain names of the proxy servers contained in the list L of SRV records obtained previously. If no name in the list L of SRV records corresponds to the domain name “proxy1.fr” of the proxy server P1 60 from which the server SVR 30 has received the request M1, an incorrect routing of the request M1 is identified thereby.

Since the request M1 has not then been received from a proxy server monitored by the network operator, the server SVR 30, in a step E4, redirects it to a proxy server monitored by the network operator belonging to the list L obtained in the step E2. This server is, in the embodiment described, the server P2 20 associated with the domain name “proxy2.fr”. The request M1 is conventionally an HTTP1 request, sent in an HTTP2/TLS format by the proxy server P2 20.

In a step G1, the proxy server P2 20 receives the request redirected by the server SVR 30. This request is more specifically received on the port 80 of the proxy server P2 20.

Since the proxy server P2 20, in normal behavior, receives only HTTP1 responses on its port 80, it determines, in a step G2, that the request has passed through a proxy server not monitored by the network operator.

Then, in a step G3, the proxy server P2 20 executes an action or a series of actions aiming to prevent or reduce the effects of an incorrect routing of the request received and/or of a subsequent request, which terminates the method for monitoring the routing of the request M1. As an illustrative example, the proxy server P2 20 sends a message to the user terminal 10 in order to alert it to a potential security fault relating to the routing of the request M1. In addition to this notification intended for the user terminal 10, an action of routing of the request M1 to the port reserved for the HTTP 2.0 protocol of the proxy server P2 20 makes it possible, for example, for the latter to perform, on the request M1, the operation which has been delegated to it by the service provider. In another embodiment, the request is redirected to the proxy server P1 60 not monitored by the network operator, in order in particular to notify it that a browser has not observed the DNS indications relating to the server SVR 30 and to the proxy server monitored by the network operator. In another embodiment, the proxy server P2 20 transmits a request to a network equipment item such as a PCRF (Policy and Charging Rules Function) in order to reduce the resources of the network (e.g. bandwidth) reserved for the user terminal 10. The different actions mentioned, preventive, corrective or even restrictive, can be combined with one another or taken individually by the proxy server P2 20.

In another embodiment, no DNS interrogation is performed in the step E2 to obtain the list of proxy servers monitored by the network operator. This list is obtained by interrogation of a local or remote database in which the proxy servers monitored by the network operator are contained. There is also no limitation as to the administration of this database which can be administered by the network operator by the service provider or by a third party.

In another embodiment, the list of proxy servers monitored by the network operator is supplied by the latter to the service provider. This can notably involve a provision of a list of proxy servers by the network operator in order for the service provider to incorporate it in a parameterizing of the server SVR 30. A seal-tightness of the system 40 with respect to the network is thus made possible and makes it possible to limit the risks of attacks on the service provider.

In another embodiment, the server SVR 30 belongs to the network of the network operator.

In another embodiment, the step G3 of execution of an action or of a series of actions in order to prevent or correct the effects of a routing to a proxy server not monitored by the operator is optional.

The method has been described with an implementation for the HTTP protocol, but it can easily be adapted to any type of client-server exchange protocol involving a proxy server for the provision of a requested service.

FIG. 2b represents a schematic diagram of the steps of the method for monitoring the routing of a request relating to a service and of the exchanges between the equipment items implementing the method according to a second particular embodiment.

In this second embodiment, as previously described in relation to the first embodiment, the server SVR 30 receives the request M1 relating to a service in the step E1 and checks, in the step E2, that the request M1 has been received from a proxy server responsible for monitoring requests for the requested service. Prior to a step E4 which will be described later, an HTTP2/TLS connection set up between the application that has transmitted the request from the user terminal UE 10 and the proxy server P2 20, is also added to the exchanges previously described in relation to the first embodiment.

In a step E2′, the server SVR 30 interrogates a resolution server 50, for example a domain name resolution server DNS in order to obtain a list of proxy servers monitored by the network operator, associated with its domain name and having an HTTP2/TLS session set up with the user terminal UE 10. For that, the IP address and the application port (UDP, TCP, etc. port) used by the terminal UE 10 are obtained by the server SVR 30, from, for example, an “X-Forwarded-For” field extracted from the header of the request M1. This IP address of the terminal UE 10, the application port, the domain name of the request and the domain name of the server SVR 30 are then sent to the domain name resolution server DNS_R 50 to interrogate it. The interrogation is, for example, an interrogation according to an extension, EDNS (Extension mechanism for DNS), of the DNS protocol defined in the IETF document RFC 2671. The EDNS interrogation notably makes it possible to additionally request SRV records associated with the domain name of the server SVR 30, connection information for an IP address of the user terminal UE 10 and a proxy server associated with the domain name of the server SVR 30. This connection information indicates, for example, if an HTTP2/TLS session is set up between a proxy server associated with the domain name of the server SVR 30 and the user terminal UE 10. The list of proxy servers obtained by this EDNS interrogation thus comprises information indicating, for each of its proxy servers, whether there is an HTTP2/TLS session set up with the user terminal UE 10 that has transmitted the request.

The resolution server 50 can alternatively be an application traffic optimization server as described in the IETF document entitled “draf-ietf-alto-protocol-24”, a conversational call setup server as described in the IETF document entitled “draft-ietf-rcweb-overview-08”, or even a content distribution network controller as described in the IETF document entitled “draft-ietf-cdni-framework-07”.

The server SVR 30 then implements the step E3 as previously described in relation to the first embodiment. An incorrect routing of the request M1 is in particular identified thereby.

In a step E5, the server SVR 30 searches the list obtained in the step E2 for a proxy server for which an HTTP2/TLS session is set up with the user terminal UE 10. This search is, for example, performed by browsing the list until a proxy server is identified for which such a connection is open. As an example, the proxy server P2 20 is identified as having such a connection.

In a step E6, the server SVR 30 sends to the proxy server P2 20 information relating to the monitoring of the routing of the request M1. This information notably comprises an IP address of the proxy server P1 60 through which the server SVR 30 has initially received the request M1, as well as the latter request.

In a step G1′, the proxy server P2 20 receives the information relating to the monitoring of the routing of the request M1 transmitted by the server SVR 30. This information comprises, in particular, the request M1, and enables the proxy server P2 20, for example from information relating to the proxy server P1 60 contained in the request M1, to determine, in a step G2′, that the request has passed through this proxy server P1 60 not responsible for monitoring requests for the service.

The method then implements a step G3′, in which the HTTP2/TLS session set up between the user terminal UE and the proxy server P2 20 can be exploited to execute an action or a series of actions aiming to prevent or reduce the effects of an incorrect routing of the request received and/or of a subsequent request, which terminates the method for monitoring the routing of the request M1. As an illustrative example, the proxy server P2 20 sends to the user terminal UE 10 a notification via the HTTP2/TLS session set up between the latter and the proxy server P2 20, in order to alert the user terminal UE 10 of a potential safety fault relating to the routing of the request M1. In another embodiment, the server can perform an action or a series of actions in order to provide the service requested by the user terminal UE 10. As described in relation to the first embodiment, the request can also be redirected to the proxy server P1 60 in order for example to notify it that an application has not observed the DNS indications relating to the server SVR 30 and to the proxy server responsible for monitoring requests for the service. The sending of a message by the proxy server P2 20 to a network equipment item such as a PCRF (Policy and Charging Rules Function) in order to reduce the resources of the network (e.g. bandwidth) reserved for the user terminal 10 is also possible. The various actions mentioned, preventive, corrective or even restrictive, can be combined with one another or taken individually by the proxy server P2 20.

In another embodiment, when no server has been identified as having an HTTP2/TLS connection set up in the step E5, the server SVR 30 does not implement the steps G1′ to G3′, and sends a redirection request to a proxy server from the list obtained in the step E2′. This server is for example the proxy server P2 20. The steps G1 to G3 are then implemented as described in relation to the first embodiment.

It is moreover stressed that, for the two embodiments described in relation to FIGS. 2a and 2b, only one domain name resolution server DNS_R 50 is represented. It is clearly understood that a number of domain name resolution servers can be interrogated by the user terminal UE 10, the proxy server P1 60, or any one of the equipment items implemented by the monitoring method, without these interrogated servers being identical to those interrogated by another of these equipment items.

A proxy server will now be described in relation to FIG. 3. Such a proxy server 20 is notably arranged to detect, on reception of a request relating to a service, a routing of the request to a proxy server responsible for monitoring requests for said service. The proxy server 20 notably comprises:
a reception module 200 arranged to receive the request;
a monitoring module 202 arranged to determine that the request has passed through a proxy server not responsible for monitoring requests;
a control module 204 arranged to control the application of a corrective action relating to the request;
a sending module 206 arranged to send a request following a command for an application of a corrective action relating to the request.

FIG. 4 represents a server 30 arranged to monitor a routing of a request relating to a service according to a particular embodiment. It notably comprises:
a reception module 300 arranged to receive the request;
a sending module 302 arranged to transmit the request to a proxy server responsible for monitoring requests for the service;
a monitoring module 304 arranged to check that the request has been received from a proxy server responsible for monitoring requests for the service;
a control module 306 arranged to, when the request has not been received from a proxy server responsible for monitoring requests for the service, control a transmission of the request relating to a service to a proxy server responsible for monitoring requests for the service;
an interrogation module 308 arranged to interrogate a domain name server to obtain a list of at least one proxy server responsible for monitoring requests for the service.

In a particular embodiment, the interrogation module 308 is not implemented. This is notably the case when the list of proxy servers responsible for monitoring requests for the service is not obtained by the interrogation of a domain name server as described previously in relation to FIG. 2.

The invention is implemented by means of software and/or hardware components. In this respect, the term “module” can, in this document, correspond equally to a software component, to a hardware component or to a set of hardware and/or software components, capable of implementing a function or a set of functions, according to what is described previously for the module concerned.

A software component corresponds to one or more computer programs, one or more subprograms of a program, or, more generally, to any element of a program or software. Such a software component is stored in memory, then given a task which is executed by a data processor of a physical entity and is capable of accessing the hardware resources of this physical entity (memories, storage media, communication bus, electronic input/output boards, user interfaces, etc.).

Similarly, a hardware component corresponds to any element of a hardware assembly. It can be a programmable or non-programmable hardware component with or without integrated processor for software execution. It can for example be an integrated circuit, a chip card, an electronic card for the execution of firmware, etc.

In a particular embodiment, the modules 200, 202, 204, 206, 300, 302, 304, 306 and 308 are arranged to implement the monitoring method described previously. They are preferably software modules comprising software instructions for having those steps of the monitoring method described previously executed, implemented by a server arranged to monitor the routing of a request relating to a service and by a proxy server. The invention therefore also relates:
to a program for a server arranged to monitor the routing of a request relating to a service, comprising program code instructions intended to control the execution of the steps of the monitoring method described previously, when said program is run by said server;
a program for a proxy server, comprising program code instructions intended to control the execution of the steps of the monitoring method described previously, when said program is run by said server;
a storage medium that can be read by a server arranged to control the routing of a request relating to a service on which is stored the program for such a server;
a storage medium that can be read by a proxy server on which is stored the program for such a server.

The software modules can be stored in or transmitted by a data medium. The latter can be a hardware storage medium, for example a CD-ROM, a magnetic diskette or a hard disk, or even a transmission medium such as an electrical, optical or radio signal, or a telecommunication network.

1. A method for monitoring the routing of a request (M1) relating to a service, said method comprising the following steps implemented by a server (30) providing said service:
reception (E1) of the request relating to a service;
checking (E3) that the request has been received from a proxy server (20) responsible for monitoring requests for said service;
and when said request has not been received from a proxy server responsible for monitoring requests for said service:
transmission (E4, E6) of said request relating to a service to at least one proxy server responsible for monitoring requests for said service.

2. The monitoring method as claimed in claim 1, wherein the request is received from a proxy server (60), the check comprising the search for said proxy server in a list of at least one proxy server responsible for monitoring requests for said service.

3. The monitoring method as claimed in claim 2, wherein the method comprises the obtaining (E2, E2′) of said list from a resolution server (50), in particular a domain name resolution server, an application traffic optimization server or a conversational call setup server.

4. The monitoring method as claimed in claim 2, further comprising the search (E5), in said list, for information identifying a proxy server connected with the equipment item having transmitted the request, the transmission step consisting in sending the request to the identified proxy server.

5. The monitoring method as claimed in claim 2, wherein said list is supplied to the server providing the service prior to the reception of said request.

6. The monitoring method as claimed in claim 1, further comprising the following steps implemented by a proxy server (20) responsible for monitoring requests for said service on reception (G1, G1′) of the transmitted request:
determination (G2) that the request has passed through a proxy server (60) not responsible for monitoring requests for said service;
application (G3) of a corrective action relating to the request.

7. The monitoring method as claimed in claim 6, wherein the corrective action belongs to a group comprising the sending of a notification to an equipment item transmitting the request, the sending of a notification to the proxy server not responsible for monitoring requests for said service through which the request has passed, a processing of the request in order to make the service requested, a recording of the request, a limitation of the resources of the network assigned for the processing of the request.

8. The monitoring method as claimed in claim 1, wherein the transmission step consists in redirecting said request to said at least one proxy server via the equipment item transmitting said request.

9. A server (30) arranged to monitor a routing of a request relating to a service, comprising:
a reception module (300) arranged to receive said request;
a sending module (302) arranged to transmit said request to at least one proxy server responsible for monitoring requests for said service;
a monitoring module (304) arranged to check that said request has been received from a proxy server responsible for monitoring requests for said service;
a control module (306) arranged to, when said request has not been received from a proxy server responsible for monitoring requests for said service, control a transmission of said request relating to a service to at least one proxy server responsible for monitoring requests for said service.

10. The server as claimed in claim 9, further comprising an interrogation module (308) arranged to interrogate a resolution server to obtain a list of at least one proxy server responsible for monitoring requests for said service.

11. A proxy server (20) arranged to detect, upon the reception of a request relating to a service, a routing of said request to a proxy server not responsible for monitoring requests, comprising:
a reception module (200) arranged to receive said request;
a monitoring module (202) arranged to determine that the request has passed through a proxy server not responsible for monitoring requests;
a control module (204) arranged to control the application of a corrective action relating to the request;
a sending module (206) arranged to send a request following a command for an application of a corrective action relating to the request.

12. A monitoring system (40), arranged to monitor the routing of a request relating to a service, comprising:
a server (30) arranged to monitor a routing of a request relating to a service, comprising:
a reception module (300) arranged to receive said request;
a sending module (302) arranged to transmit said request to at least one proxy server responsible for monitoring requests for said service;
a monitoring module (304) arranged to check that said request has been received from a proxy server responsible for monitoring requests for said service;
a control module (306) arranged to, when said request has not been received from a proxy server responsible for monitoring requests for said service, control a transmission of said request relating to a service to at least one proxy server responsible for monitoring requests for said service;
a proxy server (20) arranged to detect, upon the reception of a request relating to a service, a routing of said request to a proxy server not responsible for monitoring requests, comprising:
a reception module (200) arranged to receive said request;
a monitoring module (202) arranged to determine that the request has passed through a proxy server not responsible for monitoring requests;
a control module (204) arranged to control the application of a corrective action relating to the request;
a sending module (206) arranged to send a request following a command for an application of a corrective action relating to the request.

13. A program for a server, comprising program code instructions intended to control execution of steps of a method, when said program is run by said server, the method for monitoring the routing of a request (M1) relating to a service, said method comprising the following steps implemented by a server (30) providing said service:
reception (E1) of the request relating to a service;
checking (E3) that the request has been received from a proxy server (20) responsible for monitoring requests for said service;
and when said request has not been received from a proxy server responsible for monitoring requests for said service:
transmission (E4, E6) of said request relating to a service to at least one proxy server responsible for monitoring requests for said service.

14. A storage medium that can be read by a server on which a program for a server, comprising program code instructions intended to control execution of steps of a method, when said program is run by said server, the method for monitoring the routing of a request (M1) relating to a service, said method comprising the following steps implemented by a server (30) providing said service:
reception (E1) of the request relating to a service;
checking (E3) that the request has been received from a proxy server (20) responsible for monitoring requests for said service;
and when said request has not been received from a proxy server responsible for monitoring requests for said service:
transmission (E4, E6) of said request relating to a service to at least one proxy server responsible for monitoring requests for said service.
